(19) United States
(12) Patent Application Publication
(10) Pub. No.: US 2002/0028168 A1
(43) Pub. Date: Mar. 7, 2002

(54) Process and apparatus for producing an inert gas using an internal combustion engine

(76) Inventors: Frederick W. Giacobbe, Naperville, IL (US); Michael G. Pizzo, Yorkville, IL (US); Xavier Vigor, Chicago, IL (US)

Correspondence Address: E. Joseph P. O'Malley Gess, BURNS, DOANE, SWECKER & MATHIS, L.L.P., P.O. Box 1404, Alexandria, VA, 22313-1404, US

(21) Appl. No.: 09/803,954

(22) Filed: Mar. 13, 2001

Related U.S. Application Data
(62) Division of application No. 09/227,209, filed on Jan. 8, 1999.

(51) Int. Cl. B01D 53/34

(52) U.S. Cl. 423/212; 423/219; 60/619

(57) ABSTRACT

An inert gas production system which primarily employs the exhaust gas of an engine as an inert gas source and uses a catalytic purifier to remove oxygen from the engine exhaust to produce the inert gas. The engine is preferably an internal combustion engine which operates on methane. The catalytic purification of the exhaust gas to remove oxygen is preferably performed by a packed bed catalytic purifying system including two catalyst vessels operated in series. The inert gas production system using engine exhaust can operate at a lower cost than the known membrane purification systems which produce an inert gas from air. In addition, the engine can be connected to a generator to provide an electrical energy advantage and the entire system can produce an inert gas stream containing less than 1,000 ppm of oxygen.

### BACKGROUND OF THE INVENTION

1. Field of the Invention

This invention relates to a process and apparatus for producing an inert gas stream comprising nitrogen and carbon dioxide. More particularly, this invention relates to a process and system for producing an inert gas stream from the exhaust gas of an internal combustion engine.

2. Brief Description of the Related Art

Inert gas generating systems, which generate gas streams comprising nitrogen or nitrogen in combination with other inert gases such as carbon dioxide, are used in many different industrial applications. For example, an inert gas or an inert gas mixture may be used to prevent instantaneous combustion or explosive ignition, to limit corrosion and oxidation (as in inert gas welding applications), in semi-conductor manufacturing processes, or in specialized heat treating applications.

More specifically, inert gases may be used for inerting the ullage in large oil tanks or other types containers employed to store or deliver combustible fluids. In these cases, an inert gas or an inert gas mixture is used to fill the head space in the tanks prior to filling or during off-loading of the tanks. This precaution is employed to prevent combustion or explosions within these tanks due to the initial presence or influx of air during the filling and/or emptying process.

Inert gases have also been used to facilitate the removal of crude oil from semi-depleted oil wells. Injection of the inert gas in these wells causes some of the gas to dissolve within the residual oil reserves due to the substantial overpressure that the gas creates deep within the wells. Subsequent pressure reductions at the well head causes extreme foaming which is capable of bringing large quantities of additional oil to the surface. In other cases, multiple inert gas injection sites, surrounding a centralized non-pressurized extraction site, may be simultaneously pressurized with an inert gas or mixture of inert gases. In this case, the circumferential gas pressure alone will tend to force residual quantities of subsurface oil to flow to the well's surface region through the centralized non-pressurized extraction site.

In order for a gas to be used as an inert gas in applications in which prevention of combustion and/or oxidation is important, the oxygen content in the inert gas must be sufficiently reduced. For example, inert gases having oxygen contents of less than about 2.0 percent by volume are preferred for inerting the head space in oil tankers.

High purity cryogenic grade liquid nitrogen, which can be vaporized to produce high purity gaseous nitrogen, is usually about 99.99 percent pure (at least). This grade of nitrogen is typically employed in many different inerting processes including some of the applications already mentioned herein.

Cryogenic grade liquid nitrogen is generally made in large air separation plants and then transported in the liquid state to a point of use location where it is employed either directly as a liquid or in the gaseous state after vaporization. Argon is another kind of inert gas which is produced and employed similarly. Both the generation and transportation of high purity cryogenic grade inert gases can be very costly. Therefore, it would be desirable to be able to efficiently produce inert gases with simple on-site systems and thus avoid the transportation costs associated with delivery to point of use locations.

One method of on-site production of inert gases involves conventional membrane systems employed to produce gaseous nitrogen from air. These kinds of systems can produce gaseous nitrogen with purity levels on the order of 99 percent by volume. However, these systems are quite expensive due to energy requirements and achieve relatively low nitrogen gas flow rates at high purity production levels.

An alternative way to produce an inert gas stream is through the combustion of an organic fuel. For example, the product gas stream produced as a result of any combustion process involving the burning of gasoline, diesel fuel, or natural gas in air generally contains mostly nitrogen, some carbon dioxide, and small amounts of oxygen, carbon monoxide, and water vapor. The carbon dioxide and water vapor impurities are relatively inert and, thus, are not objectionable in many subsequent uses of the inert gas. However, for most uses a majority of the oxygen must be removed from the inert gas stream by a purification system prior to use. Water vapor can also be removed, even more easily than oxygen (typically by adsorption or by a membrane permeation technique), if necessary.

U.S. Pat. No. 3,353,921 describes the use of natural gas and air, combined in a specially designed furnace, as a means for producing inert gas mixtures. However, the use of a furnace as an inert gas generator is inefficient because furnaces are not designed to covert any of the available heat energy they produce into other more useful forms.

U.S. Pat. No. 3,389,972 describes the use of an internal combustion engine for burning hydrocarbons to produce an inert gas. The exhaust gases from the internal combustion engine are directed into a catalytic converter to destroy residual oxygen in the exhaust gases. The catalytic converter includes a catalyst that is deposited on long thin strips of metal arranged in the catalyst vessel. The catalyst strips are arranged so that the pressure drop through the catalyst is maintained at a minimum. A compressor is then used to raise the pressure of the inert gas stream exiting the catalytic purifier. This system does not take full advantage of the energy produced by the engine. In addition, pressurization of the exhaust gases after catalytic purification is undesirable because the catalyst beds must be much larger in physical size in order to properly accommodate and purify a lower pressure gas stream. Accordingly, it is desirable to provide an efficient system for producing an inert gas stream on site and substantially cut the costs associated with transportation and storage of the inert gas. And, existing techniques designed to accomplish these goals are not yet optimized.

### SUMMARY OF THE INVENTION

The present invention relates to a process and apparatus for producing an inert gas stream by combustion of an organic hydrocarbon fuel in an internal combustion engine followed by catalytic purification of the exhaust gas to substantially remove oxygen.

In accordance with one aspect of the present invention, a process for producing an inert gas includes the following steps: combustion of an organic hydrocarbon fuel in an internal combustion engine, passing the exhaust gas stream from the engine through a heat exchanger to cool the exhaust gas, operating a compressor with a fractional part of an output power of the engine, and compressing the cooled exhaust gas stream with the compressor. The compressed exhaust gas stream is then heated and additional fuel is introduced into the exhaust gas stream either prior to or after the compression step. The heated and pressurized exhaust gas stream and added fuel are then passed through a packed bed catalytic purification system to convert oxygen in the exhaust gas to carbon dioxide and water vapor and thus produce an inert gas stream containing less than 1000 ppm of oxygen.

In accordance with an additional aspect of the present invention, a process for producing an inert gas includes the steps of combusting an organic hydrocarbon fuel in an engine, and pressurizing an exhaust gas stream from the engine with a compressor operated with a fractional part of the output power from the engine. Oxygen is removed from the exhaust gas stream by passing the exhaust gas stream with an added fuel component through a purification system which includes a first cooled catalyst vessel and a second uncooled catalyst vessel.

In accordance with a further aspect of the invention, a system for producing an inert gas using an engine includes an engine which burns an organic hydrocarbon fuel or inorganic fuel, a compressor for compressing an exhaust gas stream from the engine, and a purification system. The compressor is driven by the engine to compress the exhaust gas stream. The purification system for removing oxygen from the compressed exhaust gas stream includes a first cooled catalyst vessel and a second uncooled catalyst vessel arranged in series. In addition, a heat exchanger is provided for cooling an inert gas stream exiting the first cooled catalyst vessel prior to delivery of the inert gas stream to the second catalyst vessel.

In addition to all of the foregoing operational aspects, this kind of inert gas generating system may also be capable of generating on site electrical energy using whatever power that may be leftover from the engine after all other power demand requirements have been met.

The present invention provides many advantages of an efficient on site system for the generation of an inert gas stream.

### BRIEF DESCRIPTION OF THE DRAWINGS

The invention will now be described in greater detail with reference to the preferred embodiments illustrated in the accompanying drawings, in which like elements bear like reference numerals, and wherein:

FIG. 1 is a schematic diagram of an inert gas generating system according to one embodiment of the present invention; and

FIG. 2 is a schematic diagram of a catalytic purifying system for removing oxygen from the inert gas stream according to one embodiment of the present invention.

### DETAILED DESCRIPTION OF THE PREFERRED EMBODIMENTS

An inert gas production system according to the present invention employs the exhaust gas of an engine as an inert gas source and uses a catalytic purification system to remove oxygen from the engine exhaust gas to produce the inert gas. The engine is preferably an internal combustion engine which operates using methane or natural gas as a fuel and air as an oxidizing agent. However, we do not mean to exclude the possibility that other organic or inorganic fuels could also be employed here.

The catalytic purification of the exhaust gas to remove oxygen is preferably performed in a packed bed catalytic purifying system including two catalyst vessels operated in series. The inert gas production system using engine exhaust can operate at a lower cost than the known membrane purification systems which produce an inert gas from air. The engine can also be connected to a generator to provide an additional electrical energy advantage.

The present invention provides advantages over the known internal combustion engine inert gas generating systems such as that shown in U.S. Pat. No. 3,389,972. In this known system, exhaust gases are pressurized after catalytic purification. Pressurization prior to catalytic purification as in the present invention is much more desirable because the catalytic purification beds can then be made much more compact and resulting in a decreased overall size and cost of the purification system. Moreover, the mechanical energy output of the engine may be used to operate the compressor needed to boost the pressure within the exhaust gas stream produced by the engine. No additional power source is required for this purpose.

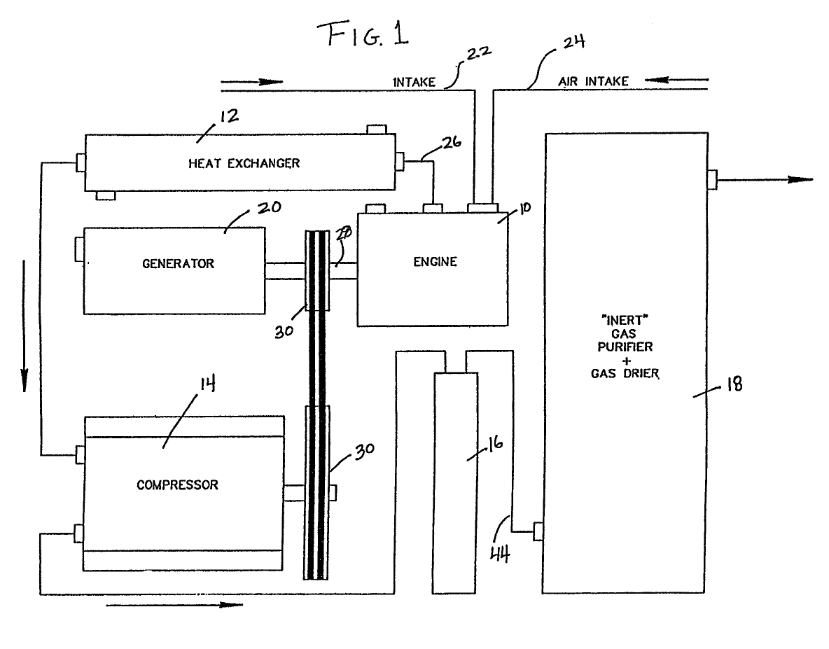

The inert gas production system of FIG. 1 includes (but is not limited to) an engine 10, a first heat exchanger 12, a compressor 14, a trap for liquified water vapor 16, and a catalytic purification system 18. A generator 20 produces electricity from the excess power output of the engine 10 that is not used to operate the compressor 14. Preferably, the system is a skid mounted system that may be easily moved as a unit to a location where the inert gas supply is needed.

As shown in the schematic of FIG. 1, the engine 10 has a fuel inlet line 22 and an air intake 24. The engine 10 may be a small type of standard internal combustion engine, such as a 10 hp, 16 hp, or 25 hp engine. Alternatively, the invention could employ a high power turbine engine or some other type of high power internal combustion engine (e.g., a diesel engine). The engine exhaust gas stream exits exhaust output line 26 of the engine. For an engine fueled by natural gas, the engine exhaust stream contains predominantly nitrogen, carbon dioxide, oxygen, and water vapor. Smaller concentrations of other gaseous and particulate impurities may also be present.

The exhaust gas stream leaving the engine may be at relatively high temperatures. For example these temperatures might range between ca. 400 and 1100 degrees C, depending upon the exact type of hydrocarbon fuel, engine, and operating parameters (e.g., the air/fuel intake ratio, the engine speed/rpm, and physical load demand placed upon the engine) employed during the internal combustion process.

This exhaust gas stream must be compressed to a pressure required by the catalytic purification system 18 which can remove a substantial portion of the oxygen from the exhaust gas stream to achieve a usable and really inert gas. However, a compressor 14 cannot efficiently handle the high temperature of the exhaust gas exiting the engine 10, and thus, the heat exchanger 12 is used to cool the exhaust gas prior to delivery to the compressor. A condensed water vapor removal stage (not shown in FIG. 1) may also be employed between an outlet port of the heat exchanger 12 and the inlet port of the compressor. This condensed water vapor removal stage will prevent liquefied water vapor from entering the compressor.

The high pressure gas stream exiting the compressor 14 is then passed through a liquefied water vapor removal trap 16 and then into a catalytic purification system 18. If necessary, additional heating of the gas stream may be done by (or within) the purification system prior to or during the purification process. The catalytic purification system 18, which will be discussed in further detail below, preferably includes two packed bed catalytic vessels which employ an organic hydrocarbon fuel, such as natural gas, as a reducing agent capable of “burning” residual oxygen within the exhaust gas stream. Small quantities of carbon monoxide, if present within the exhaust gas stream, will also be quantitatively converted into carbon dioxide within the catalytic purification system as long as added quantities of the hydrocarbon fuel are at least slightly less than that required for stoichiometric conversion of excess oxygen into carbon dioxide and water vapor. In other words, the gas purification system is preferably operated so that there are always traces (at least) of free oxygen within the purified exhaust gas stream in order to insure that all traces of carbon monoxide, if present in the first place, are converted into carbon dioxide.

The output energy of the engine 10 is used to drive both the compressor 14 and the generator 20 through an output shaft 28 and associated drive members 30. Excess energy output from the engine 10 which is not needed to run the compressor 14 runs the generator 20 to produce electricity which can be used on site or delivered back into the electrical grid. For example, in a system employing an engine, capable of producing an output power of 33 kW, a compressor 14 may use about 13 kW of the available engine power. The actual power consumed by a compressor will depend mostly upon the pressure desired at the compressor's outlet port with the remainder of the energy from the engine being delivered to the generator 20.

A “wet” exhaust gas stream from an internal combustion engine operating on a hydrocarbon based fuel source may contain (in gaseous volume percentage ranges) about 77.1-83.7 percent nitrogen, 8.8-14.5 percent water vapor, 8.6-13.2 percent carbon dioxide, 0.15-8.75 percent oxygen, 0.05-9.14 percent carbon monoxide and 0.03-4.66 percent hydrogen. Of course other exhaust gas components (e.g., nitrogen oxides) may also be present but typically in lower concentrations. Specific exhaust gas concentrations will also depend greatly upon the exact type of hydrocarbon fuel, engine, and operating parameters employed during the internal combustion process (e.g., the air/fuel intake ratio, the engine speed/rpm, and physical load demand placed upon the engine). The ranges in exhaust gas concentrations mentioned above are intended only to provide approximate information regarding possible component concentrations within the exhaust gas stream.

A “dried” exhaust gas stream, resulting from the stoichiometric (and thus theoretically perfect) combustion of pure methane or natural gas in air, would contain (in volume percentages) about 88.3 percent nitrogen and 11.7 percent carbon dioxide. We are deliberately assuming here that “air” consists only of oxygen (at 21.0 volume percent) and nitrogen (at 79.0 volume percent) and thus ignoring the presence of argon and other minor chemical constituents within air that might also end up in or contribute to any final exhaust gas stream.

The exhaust gas stream from the engine 10 is preferably purified to remove most of the oxygen and water vapor and thus form an inert gas stream usable in many applications. In addition, for some applications it may also be desirable to substantially remove or destroy any carbon monoxide that may be present within the exhaust gas stream. Removal of the water vapor can be achieved fairly easily with well known gas drier technology or gas/liquid phase separators which cool the gas and thus remove water vapor from the gas phase by condensation. However, the water vapor may not have to be removed for some applications.

Carbon dioxide may also be removed using additional purification processes. However, many applications can be found which can tolerate an inert gas mixture consisting primarily of nitrogen and carbon dioxide.

The inert gas generation system will be described below as it would be implemented using a small internal combustion engine designed or modified to use natural gas as a fuel. However, it should be understood that the method and apparatus for producing an inert gas stream according to the present invention may employ other types of engines and fuels. The fuels which may be used include generally all organic hydrocarbons including natural gas, propane, butane, fuel oil, jet fuel, gasoline, and the like. Inorganic fuels such as hydrogen, ammonia, and the like may also be used.

A 10 hp internal combustion engine can be operated with a maximum natural gas consumption of about 94 cubic feet per hour. At this maximum fuel consumption, the engine produces a total amount of inert gas of about 800 cubic feet per hour. The inert gas production of the 10 hp engine is determined as follows:

Assuming that natural gas is 100% methane, and that complete combustion occurs within the engine, the balanced chemical equation for the reaction is:

CH₄(g)+2O₂(g)═CO₂(g)+2H₂O(g)

Therefore, the 94 cubic feet per hour of natural gas would need about 188 cubic feet per hour of oxygen to burn completely. Since air contains about 21% oxygen and about 79% nitrogen (assuming the air contains only oxygen and nitrogen) about 707 cubic feet per hour of nitrogen would be delivered to the exhaust stream along with the carbon dioxide and water vapor. Assuming stoichiometric (i.e., perfect) combustion and neglecting water vapor, the total amount of inert gas produced by the 10 hp engine is expected to be roughly 800 cubic feet per hour (consisting of about 94 CFH of carbon dioxide and 707 CFH of nitrogen). Again neglecting water vapor, the concentration of carbon dioxide in the dry product gas stream would be about 11.7% by volume. Since the carbon dioxide is relatively inert, it may not be objectionable in many applications, and thus, may not be removed from the exhaust gas stream unless the end use of the purified exhaust gas stream requires removal of the carbon dioxide. However, due to non stoichiometric combustion, the residual unreacted oxygen in this exhaust stream may range between 0.15 and 8.75 volume percent, depending on the actual fuel/air mixture ratio delivered to the engine, as well as other operational parameters. In fact, a more restricted actual range of uncombined exhaust gas oxygen concentrations might lie between 0.5 and 5.0 volume percent. And in either of these cases the presence of some excess oxygen would also influence the actual dry nitrogen and dry carbon dioxide concentrations within the unpurified exhaust gas stream.

If oxygen is present in the exhaust gas stream, the catalytic purification system 18 may then be used to reduce the amount of oxygen to about 1000 ppm or less, preferably to about 500±250 ppm or less, resulting in a usable inert gas stream comprising about 88% nitrogen and about 12% carbon dioxide.

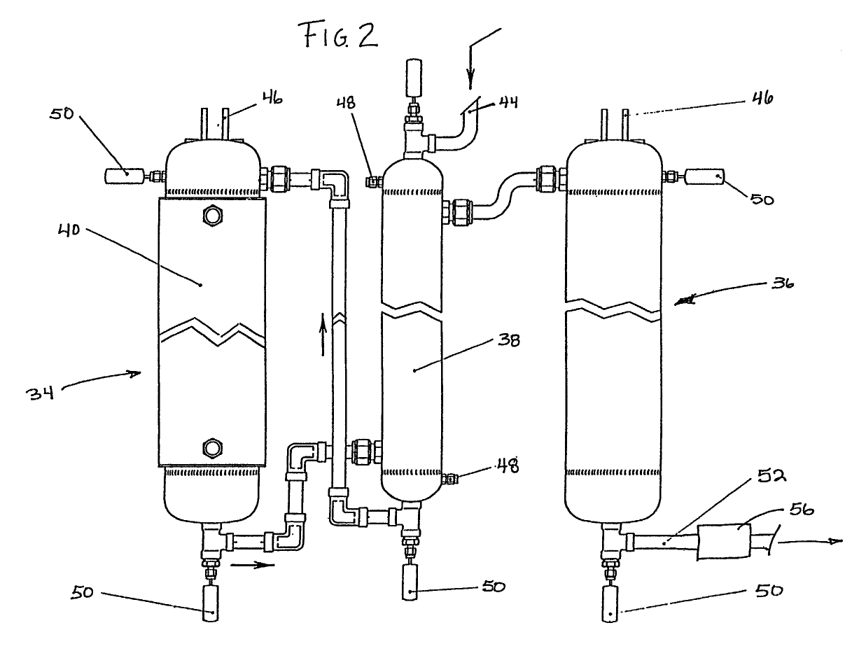

One example of a catalytic purification system 18 for removal of the residual oxygen in the exhaust gas stream from the engine 10 is illustrated in FIG. 2. The system 18 employs two catalyst vessels including a first high temperature catalyst vessel 34 and a second low temperature catalyst vessel 36 in which the undesirable components of the exhaust gas are converted, by reaction in the presence of a catalyst, to innocuous or more desirable components. In particular, the residual oxygen in the exhaust gas stream, which may occur in amounts of about 0.5-5.0%, is destroyed by combining with a supplemental flow of fuel or with unreacted fuel remaining in the exhaust gas stream. The added fuel may be one of the organic hydrocarbon fuels discussed above or may be an inorganic fuel such as hydrogen, ammonia, and the like.

This process is facilitated by the catalytic gas purifier system. Each of the catalyst vessels 34, 36 includes a packed bed catalyst. The catalyst for use in both of the catalyst vessels 34, 36 is preferably a palladium based catalyst, typically deposited upon an inert alumina ceramic support structure, such as high surface area beads or pellets, by well known methods within that art. Some acceptable catalysts include palladium, platinum, nickel, and the like, as well as combinations or mixtures of these catalysts. Other typically appropriate metallic catalysts or combinations thereof for promoting oxidation reactions are found in Periodic Table Groups 8 through 11. The catalyst covered beads or pellets are placed in the high pressure catalyst vessels to form a packed bed of catalyst material.

The catalytic purification system also includes a heat exchanger 38 which cools the inert gas stream exiting the first catalyst vessel 34 before the stream enters the second catalyst vessel 36 and preheats the gas entering the first catalyst vessel 34. Additional heating means within or outside of the first catalyst vessel 34 may also be used to preheat the gas stream entering the first catalyst vessel 34, if necessary. In addition, heaters within or outside of the second catalyst vessel 36 may also be used to preheat the gas stream entering the second catalyst vessel 36, if necessary.

The heat exchanger 38 is preferably a counter current gas/gas heat exchanger designed to transfer waste heat from the inert gas stream exiting the first catalyst vessel 34 to the incoming gas stream from the exhaust gas inlet line 44 to preheat the inlet gas stream. An additional heat exchanger (not shown), such as a gas to water heat exchanger, may be used to cool the de-oxygenated inert gas stream exiting the purification system 18 and thus assist in the partial removal of condensed water vapor from the inert gas stream.

The use of a purification system using two catalyst vessels in the present invention is preferred because an attempt to destroy all of the oxygen in a single catalyst vessel results in very high temperatures within that vessel. For example, when oxygen concentrations of approximately 1.0 volume percent and higher, in an otherwise inert gas stream, are treated in a single catalyst vessel, temperatures significantly greater than 500 degrees Celsius can be reached within that catalyst vessel. Accordingly, the first catalyst vessel 34 is designed with an external water cooled shell to reduce the shell temperature of the vessel 34. The water cooled shell 40 may be welded directly to the outer wall of the catalyst vessel 34. Preferably, the water cooled shell 40 maintains the main catalyst vessel 34 wall temperature below 500 degrees Celsius. This operational system feature permits the use of stainless steel in constructing the catalyst pressure vessels instead of using more exotic and expensive materials of construction.

The first catalyst vessel 34 having the water cooled shell 40 destroys most of the oxygen in the inert gas stream by facilitating a chemical reaction between the oxygen and fuel injected into the exhaust gas stream or present within the exhaust gas stream when it left the engine. However, even when a stoichiometric quantity of fuel is present in the purification system's inlet gas stream, excess oxygen appears in the outlet gas from the first catalyst vessel 34. This is most likely caused by a “cool wall effect” related to cooling of the of vessel 34 by the water cooled shell 40. Accordingly, purification system 18 is preferably designed to burn most of the oxygen within the first, water cooled catalyst vessel 34 and then completely burn the remaining oxygen within the second uncooled catalyst vessel 36 because there is no “cool wall effect” within that catalyst vessel 36. So, the combination of unreacted oxygen with added (and/or unreacted) fuel within the second catalyst vessel 36 can “go to completion”. In the case of the second catalyst vessel 36, no cooling shell is required because the residual oxygen concentrations entering the second catalyst vessel are so low, typically less than 1.0 percent oxygen by volume. This is a result of the primary oxidation reactions that occur within the first catalyst vessel 34. These reactions liberate large quantities of heat and concurrently reduce (significantly) the original concentration of “free” oxygen before the processed gas stream leaves the first catalyst vessel 34. Therefore, chemical oxidation reactions within the second pressure vessel do not liberate enough heat to seriously reduce the strength of properly designed stainless steel pressure vessels.

The first catalyst vessel 34 is preferably operated with only slightly less than a stoichiometric quantity of fuel. This prevents the formation (as well as promoting the destruction) of carbon monoxide because of the high temperatures within that catalyst vessel (34) and the slight excess of oxygen. These conditions tend to promote the substantial production of carbon dioxide and water vapor and practically no carbon monoxide. Actual experimental measurements within our laboratory have revealed that, under these conditions with a slight excess of oxygen, carbon monoxide concentrations within the catalytically purified exhaust gas stream (as described herein and above) are typically less than 0.5 ppm.

All of the methane or other fuel employed needed in the purification system 18 (slightly less than a stoichiometric quantity) may be added to the low pressure engine fuel inlet line, or to the low pressure/high temperature exhaust gas stream leaving the engine, or through an injection port located in the main gas stream inlet line 44 feeding the purification system. An oxygen gas analyzer 56 is positioned on a purified inert gas outlet line 52 which exits the second catalyst vessel 36. The analyzer 56 determines the amount of oxygen in the outlet inert gas stream for purposes of controlling the gas blending at the preferred inlet point. The control of the gas blending may be either manually adjusted or, preferably, automatically adjusted by a controller based on the analysis of the oxygen concentration within the outlet gas stream.

The purification system 18 also may include gas sampling ports 46 on each of the catalyst vessels 34, 36 for monitoring and testing the system. Thermocouple ports 48 and thermocouples 50 may be provided throughout the system for monitoring and controlling the temperatures throughout the system. For example, the outlet temperature of the water cooled catalyst vessel 34 measured by the thermocouple 50 at the outlet of the vessel can be automatically or manually controlled by adjusting the water flow to the water cooled shell 40 of the vessel.

According to one alternative embodiment of the invention, one or more supplemental, low pressure drop, catalytic converters are placed as close as possible to the engine's exhaust gas outlet 26. These supplemental catalytic converters make use of the hot exhaust gas stream directly from the engine to promote further chemical reactions between uncombined oxygen and unreacted fuel. The unreacted fuel may be either added to the main fuel inlet 22 of the engine 10, supplementally injected into the exhaust gas outlet line 26, and/or directly injected into the supplemental catalytic converters.

A further alternative embodiment of the invention includes the combination of a skid mounted, inert gas, catalytic purification system as described above and a backup inert gas system for use during emergency shutdown or repair of the inert gas generation system. The backup system includes a backup inert gas supply such as a supply of liquid nitrogen, other inert gas supply, bulk inert gas supply, or inert gas generation system.

The present invention relates to both the system described above and a process for producing an inert gas with this system. One such process for producing an inert gas includes the following steps: combustion of an organic hydrocarbon fuel in an internal combustion engine using a slightly air rich/fuel lean mixture, passing the exhaust gas stream from the engine through a heat exchanger to cool the exhaust gas immediately followed by removal of condensed water vapor, operating a compressor with a fractional part of the engine's output power, and compressing the cooled exhaust gas stream with the same compressor followed by removal of any additional condensed water vapor. The slightly oxygen rich compressed exhaust gas stream is then heated and additional fuel is introduced into the exhaust gas stream either prior to or after the compression step. The heated and pressurized exhaust gas stream and added fuel are then passed through a packed bed catalytic purification system to substantially remove oxygen from the exhaust gas by conversion to water vapor and carbon dioxide to produce an inert gas stream containing less than 1000 ppm of oxygen. If necessary, additional active or passive cooling of the catalytically purified gas stream may be employed along with removal of condensed and gas phase water vapor.

### Example of Internal Combustion Engine I

In actual practice, the total flow rate of exhaust gas produced by a small 10 hp internal combustion engine fueled by natural gas was measured to be 975 SCFH (27.6 m³/hr). Part of this gas flow rate was due to the presence of uncondensed water vapor. In addition, about 2% of the exhaust gas flow was analytically determined to be oxygen. However, the percentage of oxygen can vary depending on the fuel/air ratio feeding the engine as well as other factors, as noted previously herein and above. The maximum available pressure of the engine's exhaust gas stream was measured at about 8.0 psig. This pressure is not high enough to drive all the exhaust gas through the catalytic purifier 18 described above with respect to FIG. 2. Accordingly, the inert gas stream is pressurized by the compressor 14 prior to purification.

All of the power produced by the 10 hp internal combustion engine that was not needed for compression purposes could be converted into electrical power using an electrical generator also driven directly by the engine. This energy which is a byproduct of the inert gas generation system may be used to assist in compressing and purifying the exhaust gas stream or for other uses.

### Example of Internal Combustion Engine II

A second inert gas generation system, which included a standard four cycle, 25 hp, internal combustion engine, modified to operate using natural gas, was tested. This engine was connected to a 10 hp exhaust gas compressor and an electrical generator. Under one set of operating conditions, the engine's exhaust gas stream was compressed to ca. 120 psig (8.16 atm) and the total exhaust gas flow rate of the dry inert gas stream produced by this engine was estimated to be about 2,000 SCFH (56.6 m³/hr). The dried exhaust gas stream contained about 4% oxygen (determined analytically) and about 86% nitrogen and 10% carbon dioxide (estimated). The electrical power that this engine was capable of providing for other purposes after subtracting out the power consumed by the compressor was about 15 hp. Assuming a mechanical to electrical power conversion efficiency of about 85 percent, the excess 15 hp (mechanical) could be converted to about 9.5 kW of electrical power for use in the purification process or in other applications.

### Example of Catalytic Purification System

The gas purification system illustrated in FIG. 2 was operated to safely and reliably destroy oxygen present at about 5% in an inlet inert gas stream. The system was operated at inlet pressures of about 80 psig (5.4 atm) and at total inert gas flow rates of about 1200 SCFH (34 m³/hr). The system was operated at slightly below stoichiometric quantities of methane and controlled by the oxygen gas analyzer system. The system operated without creating any appreciable quantities of carbon monoxide. In particular, a calibrated carbon monoxide gas analyzer, having a detectability limit of 0.5 ppm, detected no carbon monoxide. Unreacted methane was also negligible. A separate calibrated methane gas analyzer, also having a detectability limit of 0.5 ppm, indicated that unreacted methane concentrations were less than 0.5 ppm.

Due to the inherent limitations of the oxygen analyzer employed during this work, the lowest oxygen outlet concentration level that could be maintained automatically, within the purified exhaust gas stream, was 500±200 ppm (the range here was 300 to 700 ppm). Using a more sensitive oxygen analyzer, and manual control, oxygen outlet concentration levels in the vicinity of 10 ppm were obtained. It is contemplated that oxygen concentrations at and below 10 ppm could be achieved and maintained automatically with a more highly sophisticated control system.

While the invention has been described in detail with reference to the preferred embodiments thereof, it will be apparent to one skilled in the art that various changes and modifications can be made and equivalents employed, without departing from the scope of the present invention.

What is claimed is:

1. A process for producing an inert gas comprising:
combusting an organic hydrocarbon fuel in an engine;
passing an exhaust gas stream from the engine through a heat exchanger to cool the exhaust gas;
operating a compressor with a fractional part of an output power of the engine;
compressing the cooled exhaust gas stream with the compressor;
heating the compressed exhaust gas stream;
introducing additional fuel to the exhaust gas stream;
and passing the heated/pressurized exhaust gas stream and added fuel through a packed bed catalytic purification system to convert oxygen in the exhaust gas to carbon dioxide and water vapor to produce an inert gas stream containing less than 1000 ppm of oxygen.

2. The process for producing an inert gas of claim 1, wherein the packed bed catalytic purification system includes a first water cooled catalyst vessel and a second uncooled catalyst vessel arranged in series.

3. The process for producing an inert gas of claim 2, wherein the catalytic purification system is operated using slightly less than stoichiometric quantities of fuel.

4. The process for producing an inert gas of claim 2, wherein the heating step is performed by a gas/gas heat exchanger in which a gas stream passing into the first catalyst vessel is heated by a gas stream exiting the first catalyst vessel.

5. The process for producing an inert gas of claim 1, wherein the organic hydrocarbon fuel is methane or natural gas.

6. The process for producing an inert gas of claim 1, wherein the additional fuel is an organic fuel.

7. The process for producing an inert gas of claim 1, wherein the additional fuel is an inorganic fuel.

8. The process for producing an inert gas of claim 1, wherein the engine drives both the compressor and a generator.

9. The process for producing an inert gas of claim 1, wherein the inert gas stream is produced at a flow rate of at least 500 SCFH.

10. The process for producing an inert gas of claim 1, wherein a purified inert gas stream containing less than 100 ppm of oxygen is produced.

11. The process for producing an inert gas of claim 1, wherein a purified inert gas stream containing less than 10 ppm of oxygen is produced.

12. The process for producing an inert gas of claim 1, wherein the additional fuel is delivered either into the engine, into the exhaust gas of the engine, or into the heated/pressurized exhaust gas stream exiting the compressor.

13. A process for producing an inert gas comprising:
combusting an organic hydrocarbon fuel in an engine;
pressurizing an exhaust gas stream from the engine with a compressor which is operated with a fractional part of an output power of the engine; and
removing oxygen from the exhaust gas stream by passing the exhaust gas stream with an added fuel component through a purification system including a first cooled catalyst vessel and a second uncooled catalyst vessel.

14. The process for producing an inert gas of claim 13, wherein the exhaust gas stream is cooled prior to pressurization with the compressor and condensed water vapor is removed prior to compression.

15. The process for producing an inert gas of claim 13, wherein the exhaust gas stream is cooled after pressurization with the compressor and condensed water vapor is removed prior to the catalytic purification step.

16. The process for producing an inert gas of claim 13, wherein the exhaust gas stream is cooled after catalytic purification and condensed water vapor is removed from the purified gas stream prior to its use.

17. The process for producing an inert gas of claim 16, wherein the purified exhaust gas stream is further treated after the removal of liquefied water vapor in order to remove additional quantities of gaseous water vapor from the catalytically purified gas stream prior to its use.

18. The process for producing an inert gas of claim 13, wherein the exhaust gas stream is further treated after catalytic purification in order to remove gaseous carbon dioxide from the catalytically purified gas stream prior to its use.

19. The process for producing an inert gas of claim 13, wherein the compressor pressurizes the exhaust gas stream to at least 30 psig.

20. The process for producing an inert gas of claim 13, wherein the purification system is operated with slightly less than stoichiometric quantities of fuel.

21. The process for producing an inert gas of claim 13, wherein the exhaust gas stream is heated by a gas/gas heat exchanger in which the gas stream passing into the first catalyst vessel is heated by an inert gas stream exiting the first catalyst vessel.

22. The process for producing an inert gas of claim 13, wherein the fuel is an organic hydrocarbon fuel or an inorganic fuel.

23. The process for producing an inert gas of claim 13, wherein the added fuel component is an organic fuel or inorganic fuel.

24. A process for producing an inert gas from a heated impure inert gas mixture containing up to 5.0% oxygen comprising:
providing a packed bed catalytic purification system which includes a first water cooled catalyst vessel and a second uncooled catalyst vessel arranged in series; and
passing the inert gas mixture and a combustible fuel component through the catalytic purification system.

25. The process for producing an inert gas of claim 24, wherein the catalytic purification system is operated using slightly less than stoichiometric quantities of the combustible fuel component.

26. The process for producing an inert gas of claim 24, further comprising a heating step performed by a gas/gas heat exchanger in which a gas stream passing into the first catalyst vessel is heated by a gas stream exiting the first catalyst vessel.

27. The process for producing an inert gas of claim 24, wherein the combustible fuel component is methane or natural gas.

28. The process for producing an inert gas of claim 24, wherein the combustible fuel component is hydrogen or ammonia.

29. The process for producing an inert gas of claim 24, wherein the impure inert gas is pressurized to at least 30 psig before passing through the catalytic purification system.

30. The process for producing an inert gas of claim 24, wherein a purified inert gas stream exiting the catalytic purification system is cooled and condensed water vapor is removed from the purified gas stream prior to its use.

31. The process for producing an inert gas of claim 24, wherein a purified inert gas stream exiting the catalytic purification system is further treated in order to remove gaseous carbon dioxide from the catalytically purified inert gas stream prior to its use.

32. The process for producing an inert gas of claim 24, wherein the impure inert gas stream is heated by a supplemental heating means placed within or on gas lines feeding to one or more of the catalyst vessels or outside or inside of one or more of the catalyst vessels.

33. The process for producing an inert gas of claim 24, wherein a purified inert gas stream containing less than 100 ppm of oxygen is produced.

34. The process for producing an inert gas of claim 24, wherein a purified inert gas stream containing less than 10 ppm of oxygen is produced.
